(19) United States
(12) Patent Application Publication
(10) Pub. No.: US 2007/0177692 A1
(43) Pub. Date: Aug. 2, 2007

(54) Receiver having dc offset voltage correction

(76) Inventor: Adrian W Payne, Horley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/552,227

(22) PCT Filed: Mar. 30, 2004
(86) PCT No.: PCT/IB04/01045

§ 371 Date: Oct. 6, 2005

(30) Foreign Application Priority Data
Apr. 9, 2003 (GB) 0308168.4

(51) Int. Cl. H04L 27/00

(52) U.S. Cl. 375/326

(57) ABSTRACT

A receiver comprises a frequency down-conversion stage (14) for demodulating a received signal to produce an uncorrected demodulated signal (vᵢₙ ), a dc offset voltage correcting circuit (22) having an output (28) for a corrected signal and a data recovery circuit (42) coupled to the output. The dc offset voltage correcting circuit (22) comprises an input for the uncorrected demodulated signal (vᵢₙ), a bit slicer (30) for detecting received data, a filter (32) coupled to the output of the bit slicer for regenerating the demodulated signal less noise and dc offset, a subtracting stage (34) for subtracting the regenerated demodulated signal from a delayed version of the uncorrected demodulated signal to produce the dc offset voltage (v_{off}) and a feedback circuit for feeding back the dc offset voltage to the bit slicer.

The present invention relates to a receiver having dc offset voltage correction and to a method of dc offset voltage correction in a demodulated signal. The receiver may have particular, but not exclusive, application in radio systems operating in accordance with Bluetooth™

The problem of unwanted dc offsets in radio receivers is well known and there have been many proposals for overcoming it. Patent Specification WO 02/54692 discloses a receiver having a variable threshold slicer circuit. FIG. 7 of this Specification shows an embodiment of a receiver in which provision is made for correcting for dc offset voltage so that data in a demodulated signal can be detected more accurately by slicing the signal. The dc offset voltage is initially estimated by applying the demodulated input signal to a first input of a differencing stage. A default value of a selected threshold voltage is applied to a second input of the differencing circuit and an output voltage comprising a dc offset voltage estimate plus noise is obtained. This output voltage is applied to an averaging circuit in which the voltage is averaged over a period corresponding to say 25 bit periods. A low pass filter filters the output of the averaging circuit to remove the noise and the result is stored as the dc offset voltage. In operation the stored dc offset voltage is subtracted from a selected threshold circuit to be used by a bit slicer and the difference voltage acts as a modified threshold voltage which is used by a bit slicer for slicing the demodulated voltage. Whilst this circuit functions satisfactorily it is desired that a dc offset circuit operating at frequencies used by systems such as Bluetooth™ should be more responsive.

Other techniques for compensating for dc offset voltage, base line wander and level correction all associated with unwanted disturbing influences on the signal transmission path are disclosed in U.S. Pat. Nos. 6,324,231 B1 and 6,175,728 B1, EP-A2-928215 and EP-B1-16503.

Some methods of dc offset voltage compensation are unable to be fully effective when there a long sequences of unvarying data such as 1s or 0s.

An object of the present invention is to prevent long sequences of non-varying data from affecting the dc offset voltage estimate and to make the offset estimate responsive to frequency drift.

According to a first aspect of the present invention there is provided a receiver comprising means for demodulating a received signal to produce an uncorrected demodulated signal, a dc offset voltage correcting circuit having an output for a corrected signal and a data recovery circuit coupled to the output, the dc offset voltage correcting circuit comprising an input for the uncorrected demodulated signal, a bit slicer for detecting received data, filtering means for regenerating the demodulated signal less noise and dc offset, subtracting means for subtracting the regenerated demodulated signal from the uncorrected demodulated signal to produce the dc offset voltage and a feedback circuit for feeding back the dc offset voltage to the bit slicer.

According to a second aspect of the present invention there is provided a method of dc offset voltage correction in a demodulated signal, comprising obtaining a dc free estimate of the demodulated signal, subtracting the dc free estimate of the demodulated signal from a contemporaneous version of the demodulated signal to obtain a dc offset voltage and subtracting the dc offset voltage from the demodulated signal.

The present invention is based on the concept that removing the effect of the demodulated signal from an input signal will provide an estimate of the dc offset voltage. This estimate can be subtracted from the input signal to provide a signal in which data can be detected accurately by slicing. This architecture has the advantage of preventing long sequences of non-varying data from affecting the dc offset voltage estimate and of making the offset estimate responsive to frequency drift by avoiding the use of filters having relatively long time constants.

A level correction circuit architecture disclosed in EP-B1-16503 is concerned with correcting the level of television teletext signals and differs from that used in the receiver circuit made in accordance with the present invention in that a waveform corrected signal is derived from a bit slicer coupled to an output of a level correcting circuit. Additionally the waveform corrected signal is applied to an amplitude control circuit for the correction of the “a” level corresponding to a logic one level in the television signal and it is the output from this circuit which is subtracted from an input signal to obtain an error signal. The error signal is integrated in an integrating circuit to produce a level control signal which is supplied to the level correcting circuit. The amplitude control signal corresponding to the level “a” is derived from the input signal by obtaining the difference between a logic zero level which corresponds to the black level “b” and the logic one value corresponding with a level “(b+a)” in the television signal. The levels “b” and “(b+a)” can show variations caused by disturbing influences on the transmission path. This cited circuit is not concerned with overcoming the effects of unwanted dc offset voltages. The receiver circuit made in accordance with the present invention does not need an amplitude control circuit for signal level control between two logic levels.

The present invention will now be described, by way of example, with reference to the accompanying drawings, wherein:

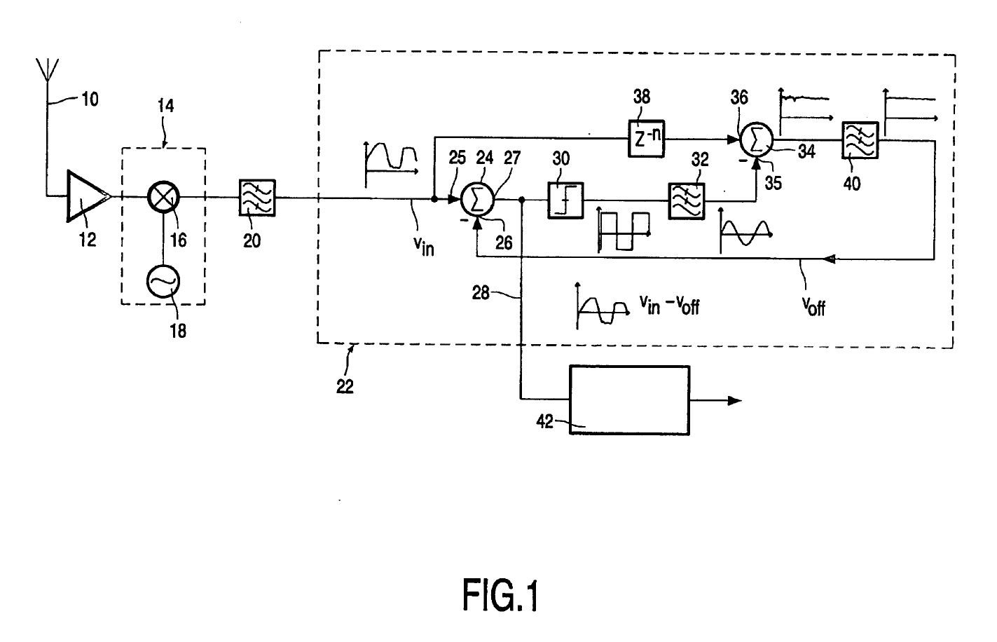

FIG. 1 is a block schematic diagram of an embodiment of a radio receiver made in accordance with the present invention,

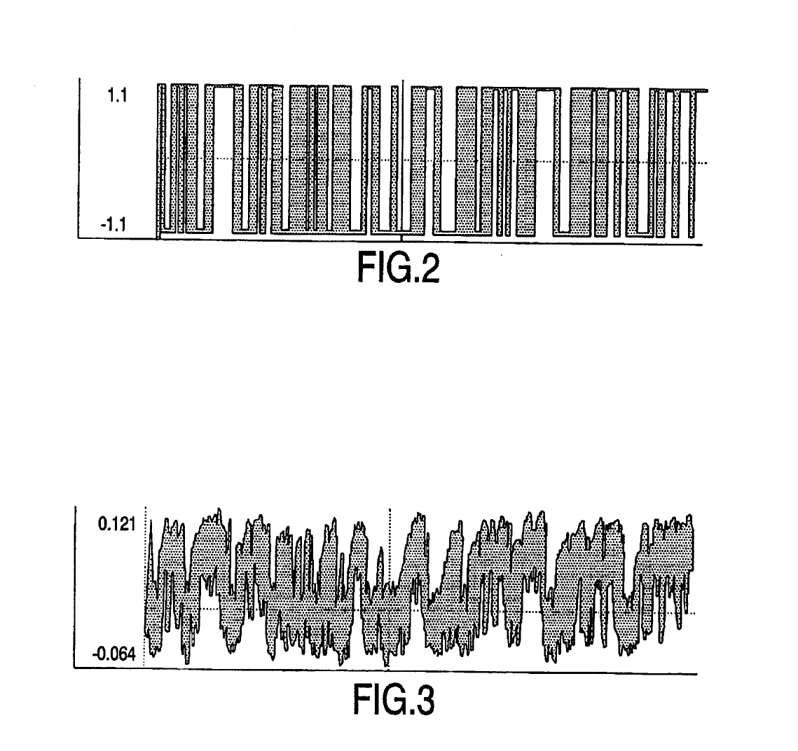

FIG. 2 illustrates a data signal in a simulated Bluetooth™ system,

FIG. 3 illustrates is a demodulated verision of the data signal shown in FIG. 2,

FIG. 4 illustrates a dc estimate obtained using the dc offset voltage circuit included in the receiver shown in FIG. 1, and

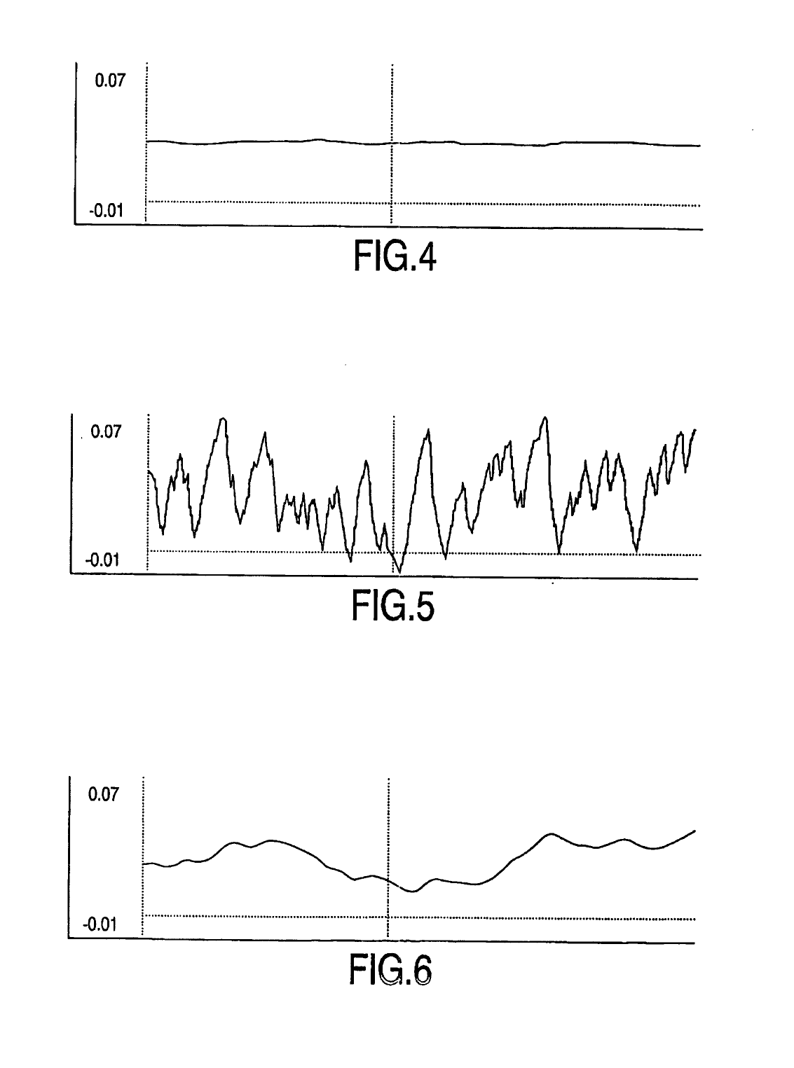

FIGS. 5 and 6, for the sake of comparison only, respectively illustrate dc offset voltage estimates obtained using a simulated “MaxMin” circuit and a simulated 10 kHz bandwidth low pass filter.

Referring to FIG. 1, the illustrated radio receiver comprises an antenna 10 for receiving for example a Bluetooth™ signal which may comprise random data as well as long sequences of non-varying data, viz long sequences of ones or zeros. The received signal is amplified in a rf amplifier 12 and the amplified signal is applied to a frequency down-conversion stage 14. The frequency down conversion stage 14 comprises a mixer (or multiplier) 16 having a first input coupled to an output of the rf amplifier 12 and a second input coupled to a local oscillator signal generating means 18, for example a frequency synthesizer. A bandpass filter 20 is coupled to an output of the frequency down-conversion stage 14 to select an uncorrected demodulated signal vᵢₙ which includes a dc offset voltage and noise.

The uncorrected demodulated signal vᵢₙ is supplied to a dc offset voltage correction circuit 22. Waveform diagrams have been provided to facilitate an understanding of the operation of the dc offset voltage correction circuit 22. The circuit 22 comprises a first subtracting stage 24 having a first input 25 for the uncorrected demodulated signal v_{in+L, a second input 26 for a dc offset voltage V}_{off} recovered by the circuit and an output 27. The signal on the output 27 is the uncorrected demodulated signal minus dc offset voltage, (vᵢₙ−v_{off}), which is supplied to a bit slicer 30 and by way of a line 28 to a data recovery stage 42. The output of the bit slicer 30 comprises an estimate of the demodulated signal and this signal is supplied to a low pass filter 32 which produces a dc free estimate of the demodulated signal. The low pass filter 32 has a characteristic which approximates to the transfer function of the transmit bit shaping filter and the complete receive chain including for example a channel filter and the demodulator. In the case of a Bluetooth™ system the low pass filter 32 could be modeled as a 300 kHz bandwidth 5^{th} order Tchebycheff 0.5 dB ripple filter.

A second subtracting stage 34 has a first input 35 coupled to an output of the low pass filter 32, a second input 36 coupled to a time delay stage 38 for delaying the uncorrected demodulated signal vᵢₙ by a time corresponding to the propagation of the signal through the circuit stages 24, 30 and 32, and an output. The output signal from the second subtracting stage 34 is the contemporaneous dc offset voltage plus noise. The noise is removed using a low pass filter 40 to provide the dc offset voltage v_{off} which is fed back to the first input 26 of the first subtracting stage 24. The time constant of the low pass filter 40 should be made as short as practically possible.

In implementing the dc offset voltage correction circuit 22 the performance can be enhanced by use of an intelligent bit slicer 30 and by using a variable bandwidth filter controlled by the estimated rate of drift in place of the low pass filter 40.

The performance improvement of this method of correcting for dc offset voltages becomes particularly apparent when data is not entirely random but contains long sequences of non-varying data as shown in FIGS. 2 to 4. More particularly FIGS. 2 to 4 show simulation results for a Bluetooth™ system. A fixed DC error of 0.03 has been applied, which is equivalent to about 100 kHz error. FIG. 2 shows the data, FIG. 3 shows the demodulated signal, and FIG. 4 shows the dc offset voltage estimation.

For the sake of comparison only, FIGS. 5 and 6 respectively illustrate the results of simulating signal cancellation feedback dc offset estimations using the so-called “MaxMin” circuit in which the dc offset voltage is the average of maxima and minima of the signal and a conventional integration technique using a 10 kHz bandwidth low pass filter. Although the relative performance of these techniques depends on the optimization of the filters it is clearly evident that the “MaxMin” circuit is particularly inferior when used with long sequences of non-varying data and, although the integration technique is better, it is still inferior to the results obtained using the described dc offset voltage correction circuit.

Although the present invention has been described with reference to a receiver having dc offset voltage correction, the teachings of the present invention may be applied to automatic frequency control (AFC) subject to the dc offset voltage estimation being more rapid than the delay through the receiver and the AFC loop thereby avoiding introducing unwanted oscillation.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of radio receivers and component parts therefor and which may be used instead of or in addition to features already described herein.

1. A receiver comprising means (14) for demodulating a received signal to produce an uncorrected demodulated signal, a dc offset voltage correcting circuit (22) having an output (28) for a corrected signal and a data recovery circuit (42) coupled to the output, the dc offset voltage correcting circuit (22) comprising an input for the uncorrected demodulated signal (vᵢₙ), a bit slicer (30) for detecting received data, filtering means (32) for regenerating the demodulated signal less noise and dc offset, subtracting means (34) for subtracting the regenerated demodulated signal from the uncorrected demodulated signal to produce the dc offset voltage (v_{off}) and a feedback circuit for feeding back the dc offset voltage to the bit slicer.

2. A receiver as claimed in claim 1, characterized in that the filtering means (32) is a low pass filter having a characteristic substantially the same as the transfer function of at least the complete receiver chain.

3. A receiver as claimed in claim 2, characterized by delay means (38) for delaying the uncorrected demodulated signal by at least the duration of the time delay due to the transmission of a signal through the filtering means.

4. A receiver as claimed in claim 1, characterized in that the feedback circuit includes a low pass filter (40).

5. A receiver as claimed in claim 1, characterized in that the feedback circuit includes a variable bandwidth filter controlled by the estimated rate of drift.

6. A receiver as claimed in claim 1, characterized by another subtracting stage (24) having a first input (25) for the uncorrected demodulated signal (vᵢₙ) and a second input (26) for the dc offset voltage (v_{off}) and an output (27) coupled to the bit slicer (30) and to the data recovery circuit (42).

7. A method of dc offset voltage correction in a demodulated signal, comprising obtaining a dc free estimate of the demodulated signal, subtracting the dc free estimate of the demodulated signal from a substantially contemporaneous version of the demodulated signal to obtain a dc offset voltage and subtracting the dc offset voltage from the demodulated signal.

8. A method as claimed in claim 7, characterized by bit slicing a difference signal formed by subtracting the dc offset voltage from the demodulated signal to provide an estimate of the demodulated signal and by filtering the estimate of the demodulated signal to obtain a dc free estimate of the demodulated signal.

9. A method as claimed in claim 7, characterized by filtering the dc offset voltage.

10. A method as claimed in claim 7, characterized by delaying the demodulating signal prior to subtracting the dc free estimate of the demodulated signal.
